(19) United States
(12) Patent Application Publication
(10) Pub. No.: US 2014/0105358 A1
(43) Pub. Date: Apr. 17, 2014

(54) MOBILE X-RAY GENERATION APPARATUS AND MOBILE X-RAY IMAGING SYSTEM

(71) Applicant: CANON KABUSHIKI KAISHA, Tokyo (JP)

(72) Inventor: Shinji Nishimura, Yokohama-shi (JP)

(21) Appl. No.: 14/050,032

(22) Filed: Oct. 9, 2013

(30) Foreign Application Priority Data
Oct. 12, 2012 (JP) 2012-227184

(51) Int. Cl. G01N 23/04

(52) U.S. Cl. CPC G01N 23/04
USPC 378/62; 378/198; 378/98.2

(57) ABSTRACT

A mobile X-ray generation apparatus includes an X-ray tube unit, a collimator configured to shape an X-ray bundle generated by the X-ray tube unit, a positioning member configured to arrange the X-ray tube unit and the collimator at respective specific positions, a cart configured to support the positioning member, a first handle fixed to the X-ray tube unit, a second handle fixed to a side surface of the collimator, and a storage portion provided in the cart and configured to protect an exit surface and the side surfaces of the collimator when the X-ray tube unit and the collimator in a stored state in which the X-ray tube unit and the collimator are brought into the storage portion.

### BACKGROUND

1. Technical Field

The present invention relates to a mobile x-ray generation apparatus and a mobile X-ray imaging system.

2. Description of the Related Art

Mobile X-ray generation apparatuses an X-ray tube unit which generates X-rays, and a collimator which shapes an X-ray bundle, each of which are attached along an boom. The boom is a cantilever, which is supported at one end by a support column with a fixture sandwiched therebetween. A caster and four drive wheels are also attached to a cart which retains the support column, so that the cart and thus the X-ray generation apparatus are movable.

However, an X-ray generation unit such as an X-ray tube and a collimator may collide with a structure in a hospital environment, while being moved, so that damage or malfunction may occur.

### SUMMARY

According to an aspect of the present disclosure, a mobile X-ray generation apparatus includes an X-ray tube unit, a collimator configured to shape an X-ray bundle generated by the X-ray tube unit, a positioning member configured to arrange the X-ray tube unit and the collimator at respective specific positions, a cart configured to support the positioning member, a first handle fixed to the X-ray tube unit, a second handle fixed to a side surface of the collimator, and a storage portion provided in the cart and configured to protect an exit surface and the side surfaces of the collimator when the X-ray tube unit and the collimator in a stored state in which the X-ray tube unit and the collimator are brought into the storage portion.

Further features of the present disclosure will become apparent from the following description of embodiments with reference to the attached drawings. Each of the embodiments of the present invention described below can be implemented solely or as a combination of a plurality of the embodiments or features thereof where necessary or where the combination of elements or features from individual embodiments in a single embodiment is beneficial.

### BRIEF DESCRIPTION OF THE DRAWINGS

FIG. 1 is an external view illustrating an arrangement during movement of a mobile X-ray generation apparatus according to an embodiment of the present invention.

FIG. 2 is an external view of the mobile X-ray generation apparatus according to the embodiment of the present invention as viewed by an operator during normal movement of the apparatus.

FIG. 3 is an external view illustrating an arrangement during movement of a mobile X-ray generation apparatus according to another exemplary embodiment of the present invention.

FIG. 4 is an external view of an X-ray generation unit in the mobile X-ray generation apparatus according to the present invention as viewed in an axial direction of an arm.

FIG. 5 is an external view of the X-ray generation unit in the mobile X-ray generation apparatus according to the embodiment of the present invention as viewed from the side of the arm.

FIG. 6 is a block diagram illustrating a control system in the mobile X-ray generation apparatus according to the embodiment.

FIG. 7 is a schematic view illustrating a rotation mechanism in the X-ray generation unit according to the embodiment.

FIG. 8 is a schematic view illustrating an operation performed when the X-ray generation unit is moved to a storage portion in the mobile X-ray generation apparatus according to the embodiment.

FIG. 9 is a flowchart illustrating the flow of interlock control of the mobile X-ray generation apparatus according to the embodiment.

FIG. 10 is a flowchart illustrating the flow of another control of the mobile X-ray generation apparatus according to the embodiment.

### DESCRIPTION OF THE EMBODIMENTS

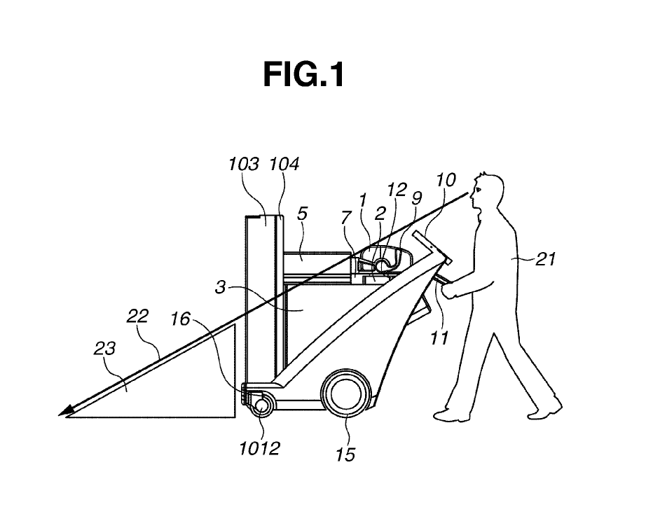

A mobile X-ray generation apparatus according to an embodiment of the present invention will be described with reference to FIG. 1. The mobile X-ray generation apparatus is generally referred to as an X-ray visiting cart, and includes an X-ray tube unit 1 that generates an X-ray bundle (X-ray beam), a collimator 2 that shapes the X-ray bundle generated by the X-ray tube unit 1, a first support post 103, a second support post 104, and an arm 5 each serving as a positioning member for arranging the X-ray tube unit 1 and the collimator 2 at respective specific positions, and a cart 16 for moving the positioning members and associated apparatus. A tube handle 9 serving as a first handle for moving the X-ray tube unit 1 is fixed to the X-ray tube unit 1. A collimator handle 12 serving as a second handle is fixed to a side surface of the collimator 2. The cart 16 includes a storage portion 7 for receiving the X-ray tube unit 1 and the collimator 2 when not in use, as illustrated in FIG. 1. A state where the X-ray tube unit 1 and the collimator 2 are arranged the storage portion 7 may be referred to as a stored state. The X-ray tube unit 1 and the collimator 2 may be collectively referred to as an X-ray generation unit. A first support post 103 and a second support post 104 may be collectively referred to as a support post 4.

The storage portion 7 is arranged to protect an exit surface (from which X-rays are emitted when in use, and the side surface of the collimator 2 when the X-ray tube unit 1 and the collimator 2 are brought into the storage portion 7. When the X-ray generation unit is in the stored state, the chance of the X-ray generation unit, including the X-ray tube unit 1 and the collimator 2, colliding with a structure in a hospital and being damaged is reduced.

Also as illustrated in FIG. 1, for example, when the X-ray generation unit is brought into the stored state, the storage portion 7 covers the side surface of the collimator 2. Thus the collimator handle 12 provided on the side surface of the collimator 2 is stored at a position where an operator 21 cannot easily grip the handle 12. However, the tube handle 9 provided in the X-ray tube unit 1 is arranged at a position where it is more easily gripped by the operator 21 than the collimator handle 12, when the X-ray generating unit is in the stored sate, because it is arranged above the collimator 2. Thus, the X-ray tube unit 1 is easily moved by an operator between a stored position and an imaging position with the tube handle 9.

In the embodiment illustrated in FIG. 1, the X-ray tube unit 1 is supplied with power from a battery arranged in an internal area of the cart 16, to generate X-rays from an exit surface in a predetermined emission direction according to control by a system control unit 3. In the example illustrated in FIG. 1, the emission direction is a downward direction, and the exit surface is a lower surface of the X-ray tube unit 1. The collimator 2 provided on the exit surface of the X-ray tube unit 1 shapes the generated X-ray bundle.

The collimator 2 has a plurality of shielding members in its inner part, and can shape the X-ray bundle into any shape by moving the shielding members. For example, the collimator 2 can shape the X-ray bundle into a square shape and a circular shape of any size, as viewed from a cross section perpendicular to the emission direction of X-rays using the shielding members. While the X-ray bundle has a cone beam shape, the emission direction of X-rays means a direction crossing the exit surface of the collimator 2 at right angles unless otherwise specified.

The system control unit 3 controls generation conditions and generation timing of X-rays generated by the X-ray tube unit 1. For the generation timing, the system control unit 3 is responsive to an irradiation switch (not illustrated) connected thereto being pressed by the operator 21 for transmitting an instruction to rotate a rotor of the X-ray tube unit and start irradiation to the X-ray tube unit 1.

A positioning member for arranging the X-ray tube unit 1 and the collimator 2 at respective specific positions will be described. In the embodiment illustrated in FIG. 1, the support post 4 extending in a vertical direction and supporting the arm 5 has a multistage configuration, and thus expands and contracts. The support post 4 includes the first support post 103 fixed to the cart 16 and the second support post 104 serving as a movable support post coupled to the first support post 103 so as to be elevatable, as illustrated in FIG. 1, for example. The second support post 104 moves upward and moves downward by a counter balance and a spring, for example, and an operation regulation unit, e.g., a non-excitation operation brake (an off brake) retains its position. Thus, the support post 4 becomes expandable/contractable, and can elevate the X-ray generation unit in a vertical direction. The support post 4 is rotatable in an axial direction with respect to the cart 16, and rotates so that the arm 5 and the X-ray generation unit supported on the arm 5 rotate.

As illustrated in FIG. 1, when the X-ray generation unit is brought into a stored state prior to moving the apparatus, the support post 4 is in a most contracted state. Thus, the support post 4 is lowered in the stored state so that a field of view to the front of the cart is ensured. The support post 4 may be brought into the most contracted state but a substantially contracted state, e.g., a state where it is extended by only 10% or 5% of a movable range, for example. An expanded/contracted state of the support post 4 in the stored state may be set in comprehensive consideration of the size of the cart 16, the maximum height of the support post 4 to be requested, and the length of the arm 5.

The arm 5 has its one end fixed to the second support post 104, and the X-ray generation unit fixed to the other end thereof. As illustrated in FIG. 1, the arm 5 can use a structure fixed to the second support post 104 so as to be elevatable. The arm 5 moves upward and moves downward by a counter balance and a spring, similarly to the second support post 104, and the non-excitation operation brake, for example, retains its position. The arm 5 has a plurality of members engaging in a nested or telescopic shape, and is movable in an axial direction of the arm 5. Such a configuration causes the arm 5 to be expandable/contractable. The expansion/contraction of the arm 5 enables the X-ray generation unit to be arranged at a position further away from the cart 16.

A monitor 10 displays is adapted to display information regarding the subject of X-ray imaging in addition to an X-ray generation conditions of the X-ray generation unit. The mobile X-ray generation apparatus, together with an imaging device, is used as a mobile X-ray imaging system. The imaging device is a device that detects X-rays, which have been generated according to a generation condition to penetrate a subject, to obtain an image, and is a digital X-ray detector using a film, an imaging panel (IP) cassette of computed radiography (CR), or a semiconductor sensor. The digital X-ray detector is a portable digital X-ray detector using an X-ray image sensor composed of a semiconductor, for example. Particularly, the digital X-ray detector can be provided with a wireless communication unit and a wired communication unit that transmit an obtained digital X-ray image to the system control unit 3.

If a digital X-ray detector such as a flat panel detector (FPD) includes a photoelectric conversion circuit having a plurality of photoelectric conversion elements for converting radiation into an electric signal arranged therein in a matrix shape, a phosphor evaporated on the photoelectric conversion circuit, and a reading circuit for reading out an electrical signal obtained by the phosphor and the photoelectric conversion circuit converting X-rays from the photoelectric conversion circuit when used as the imaging device. When an object is irradiated with X-rays, the phosphor converts the X-rays into visible light. The object transmits the X-rays. In each of the photoelectric conversion elements of the photoelectric conversion circuit, photoelectric conversion related to the transmitted X-rays is performed, and a signal charge corresponding to an amount of the transmitted X-rays is stored in the photoelectric conversion element. The reading circuit drives each of signal lines of the photoelectric conversion circuit, to control a switch element to which the photoelectric conversion element is connected, as needed, so that the respective signal charges stored in the photoelectric conversion elements are sequentially read out as electric signals, amplified, and output. Thus, in an FPD-compliant mobile X-ray generation apparatus, the monitor 10 and an image processing unit, together with the FPD, may be mounted on the same cart 16 from an advantage of the FPD that an image can be formed immediately after X-ray imaging.

In addition, an operation unit of the touch panel type is desirably incorporated into the monitor 10. Setting of an imaging preparation includes an instruction to start to receive an imaging order from a radiology information system (RIS), an instruction to sequentially select the received imaging order, an instruction to select one of a plurality of imaging operations included in the selected imaging order, an instruction to confirm and change an imaging target region related to the selected imaging operation, an imaging condition of the digital X-ray detector, or an X-ray generation condition, and an instruction to start the imaging operation. The system control unit 3 controls at least either of the wireless communication unit and the wired communication unit included in the system control unit 3 in response to the instruction to start to receive the imaging order, to receive information about the imaging order from the RIS. A display control unit in the system control unit 3 displays information about the subject corresponding to the selected imaging order on the monitor 10 while displaying at least one imaging system included in the imaging order side by side in response to the instruction to select the imaging order. The system control unit 3 notifies a change in a condition to the digital X-ray detector and the X-ray generation unit in response to instructions to change an imaging site, an imaging condition, and an X-ray generation condition. The system control unit 3 instructs the X-ray generation unit to generate X-rays while acquiring digital X-ray image data obtained by the generation from the digital X-ray detector and causing the display control unit to display the acquired digital X-ray image data on the monitor 10 in response to the instruction to start imaging.

The cart 16 retains the X-ray tube unit 1, the collimator 2, the drive unit (system control unit) 3, the support post 4, and the arm 5. The cart 16 includes a cart body for supporting a front wheel 1012 and a drive wheel 15, and a housing formed on the cart body. Therefore, the inside of the cart 16 means the inside of the housing. The cart body includes the front wheel 1012 and the drive wheel 15 that support moving power and a weight. The system control unit 3 including an X-ray high-voltage generation device, an X-ray control device, and a control panel, and a battery are mounted in the housing in the cart 16.

A moving handle 11 is a griping unit, which can be gripped by the operator 21 for moving the mobile X-ray generation apparatus using the cart 16.

In the example illustrated in FIG. 1, a field of view in front of the operator 21 who grips the moving handle 11 for moving the cart 16 is above a line of sight 22. The cart 16, the monitor 10, the X-ray tube unit 1, the arm 5, the second support post 104, and the first support post 103 mainly prevent a field of vision. An area that is not visible to the operator is roughly represented by a range 23.

The storage portion 7 has a recessed portion formed by reducing the height of a part of an upper surface of the housing in the cart 16. The storage portion 7 can reduce the height of the X-ray generation unit when arranged at a stored position to improve the field of view while lowering the center of gravity of the mobile X-ray generation unit to improve stability.

In the example illustrated in FIG. 1, the recessed portion is formed when surrounded on all four sides by a wall member formed integrally with the housing. If the X-ray tube unit 1 and the collimator 2 are brought into the stored state, the wall member is in a close proximity to the collimator 2 at a minimum distance of 10 cm or less, for example. By such an arrangement, the wall member covers the collimator 2 so that the collimator handle 9 is also covered with the wall member.

The storage portion 7 need not cover the entire side surface of the collimator 2 at the stored position. If the storage portion 7 is configured to cover 50% or more of the side surface of the collimator 2, for example, the configuration is desirable as a function of protecting the storage portion 7. If the storage portion 7 is configured to cover approximately 30% of the side surface of the collimator 2, for example, the storage portion 7 restricts movement of the X-ray generation unit even when the mobile X-ray generation apparatus collides with an external structure. Thus, the configuration is sufficient to protect the apparatus in the storage portion 7. The height of a wall surface of the storage portion 7, i.e., the depth of the storage portion 7 is determined from various viewpoints such as the sizes such as the height and the width of the housing on the cart 16, a range of a field of vision to be ensured, and enhancement of the protecting function. In the example illustrated in FIG. 1, the storage portion 7 covers 80% or more of the side surface of the collimator 2. In the example illustrated in FIG. 1, an upper end of the monitor 10 is at a position higher than the arm 5 and the X-ray generation unit in the stored state, and is fixed to a position vertically above the collimator 2. While the arm 5 and the X-ray generation unit are arranged to be low not to obstruct a field of vision, the monitor 10 on which an image and subject information are displayed is arranged to be higher. Therefore, the monitor 10 is made easily visible even if the operator 21 who mainly looks forward while moving does not greatly move the line of sight 22.

The X-ray generation unit is in an arrangement relationship in which display information of the monitor 10 is exposed to be confirmable even when at a stored position (home position). A significant advantage is that even if there is no case where the information about the monitor 10 is confirmed while the mobile X-ray generation apparatus is just moving, the information about the monitor 10 can also be confirmed if the X-ray tube unit 1 is at a home position when the mobile X-ray generation apparatus is waiting in front of a hospital room or when another health care provider is positioning a patient.

The tube handle 9 is fixed to a side surface of the X-ray tube unit 1, and includes a rod-shaped member extending in a direction opposite to the emission direction of X-rays (upward in FIG. 1). Thus, even if the X-ray tube unit 1 is stored at the stored position, the rod-shaped member extending upward can be gripped to raise the X-ray tube unit 1 upward and take the X-ray tube unit 1 out of the stored position to easily arrange the X-ray tube unit 1 at an imaging position.

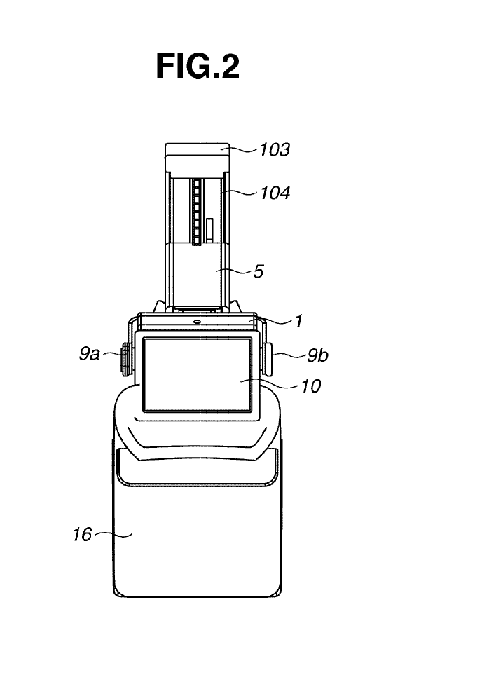

FIG. 2 is an external view in which the mobile X-ray generation apparatus according to the present embodiment is viewed from a viewpoint of the operator 21.

A pair of tube handles 9a and 9b is fixed to two side surfaces of the X-ray tube unit 1 from a viewpoint of ease of operation. In an example illustrated in FIG. 2, the two tube handles 9a and 9b are respectively provided on the two side surfaces in a forward movement direction of the mobile X-ray generation apparatus. The collimator 2 and collimator handles 12a and 12b fixed to the collimator 2, which are concealed in the storage portion 7, are respectively provided on the two side surfaces below the tube handles 9a and 9b. The forward movement direction of the mobile X-ray generation apparatus means a direction in which the mobile X-ray generation apparatus moves when the front wheel 1012 and the drive wheel 15 are at their respective initial positions, i.e., an upward direction in FIG. 2 and a leftward direction in FIG. 1.

In the example illustrated in FIG. 2, the width of the storage portion 7 is substantially similar to the width of the X-ray tube unit 1. The tube handle 9 protrudes from the side of the X-ray tube unit 1, and is provided at a position spaced outward from an emission center or the emission direction of X-rays from the collimator handle 12 stored in the storage portion 7. By such an arrangement, the tube handle 9 can be easily gripped even during movement.

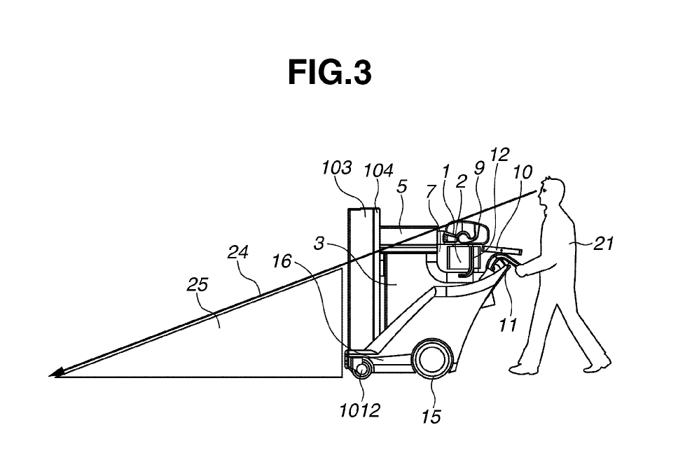

FIG. 3 illustrates a mobile X-ray generation apparatus according to another embodiment. Components assigned the same reference numerals as those assigned to the components illustrated in FIG. 1 are similar to the components, and hence description thereof is not repeated. Different portions from those illustrated in FIG. 1 will be described.

In an example illustrated in FIG. 3, the X-ray tube unit 1 is stored at a position higher than that in the first embodiment not to cause a collimator 2 to cut into a system control unit 3 in a main body of the movable X-ray generation apparatus. A field of front vision in such a state is above a line of sight 24. An area, which is invisible by a main obstruction to a field of vision, is more significantly increased than that in the first embodiment, and is substantially represented by an invisible range 25.

A storage portion 7 is formed as a recessed portion obtained by reducing the height of an upper surface of a cart 16 in the forward movement direction of the mobile X-ray generation apparatus. Thus, front and rear surfaces of the collimator 2 are protected. The storage portion 7 has a configuration in which wall portions on the lateral sides in the forward movement direction are removed, and a collimator handle 12 is exposed to be accessible from the lateral side. Such a configuration enables the X-ray tube unit 1 to be moved using the collimator handle 12 even in the stored state. The X-ray generation unit using the collimator handle 12 can also be stored. At this point, a tube handle 9 may not be provided in a configuration illustrated in FIG. 3.

In the example illustrated in FIG. 3, similar to the example illustrated in FIG. 1, the system control unit 3 includes a communication unit that wirelessly receives X-ray image data obtained by detecting X-rays emitted from an exit surface of the collimator 2 from a digital X-ray imaging unit. The received X-ray image data is displayed on a monitor 10 according to control by the system control unit 3. The monitor 10 is fixed to a position vertically above the exit surface of the collimator 2 in the stored state. Thus, the X-ray image data and subject information displayed on the monitor 10 to be visibly exposed even while the X-ray generation unit is in the stored state, similar to the example illustrated in FIG. 1.

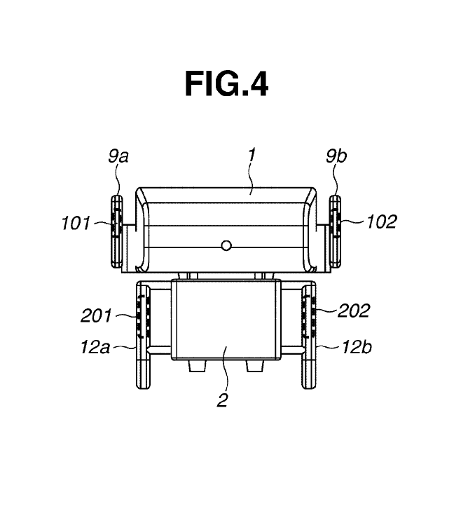

FIG. 4 is an external view of the X-ray generation unit according to the present embodiment as viewed from the operator 21. A structure indicated by a dotted line in FIG. 4 represents a member that is directly invisible from a viewpoint of the operator 21. Tube handles 9a and 9b and collimator handles 12a and 12b are provided, respectively, with tube handle switches 101 and 102 and collimator handle switches 201 and 202 for controlling an operation of the positioning member. The switches are respectively push-button switches for unlocking the positioning member, for example, and are connected to the system control unit 3. Each of the switches 101, 102, 201, and 202 is responsive to being brought into at least one of a state where it is pressed by the operator 21 (a pressed state, a first state) and a state where it is not pressed (a non-pressed state, a second state) for outputting a signal, for example. Any one of the switches 101, 102, 201, and 202 is pressed so that a signal indicating that the switch has been pressed is input to the system control unit 3. If the switch, which outputs a signal in the first state and does not output a signal in the second state, is used, the system control unit 3 detects that the switch is in the first state for the reason that the signal is not output.

The system control unit 3 detects this input, and deregulates the non-excitation operation brake serving as an operation regulation unit of the deadman lock type. Thus, the positioning member is unlocked, and the operator 21 can move the X-ray generation unit to a target location. Only while the switch is pressed, the positioning member is unlocked. While the switch is not pressed, the non-excitation operation brake is immediately operated, to regulate movement of the positioning member. Safety can be enhanced by using the operation regulation unit of the deadman lock type.

In consideration of a case where an excessive operation load is applied to the operator 21 by a weight, for example, elevation of an arm 5 with respect to a support post 4 including a first support post 103 and a second support post 104 and elevation of the second support post 104 with respect to the first support post 103, an electric mechanism for operating movable members of the support post 4 and the arm 5 can be provided. The electric mechanism includes an actuator including a motor. The electric mechanism includes a mechanism controlled to operate in response to an electric signal, for example, a solenoid actuator using power obtained by an electromagnet, for example. The electric mechanism has its driving timing and its movement amount or rotation amount controlled by an electric control unit serving as a part of the system control unit 3. In this case, the electric control unit is responsive to the switches 101, 102, 201, and 202 being pressed for unlocking the movable members while driving the electric mechanism and maintaining positions of the movable members, to prevent the arm 5 and the second support post 104 from moving down even if it does not apply an operating force thereto. This can reduce the possibility that the X-ray generation unit collides with another structure due to the downward movement.

The switches 101 and 102 and 201 and 202 for releasing locking are respectively provided in the tube handles 9a and 9b and the collimator handles 12a and 12b. While the two tube handles 9a and 9b and the two collimator handles 12a and 12b are provided, the present invention is not limited to this structure. The respective numbers of tube handles and collimator handles may be reduced to one.

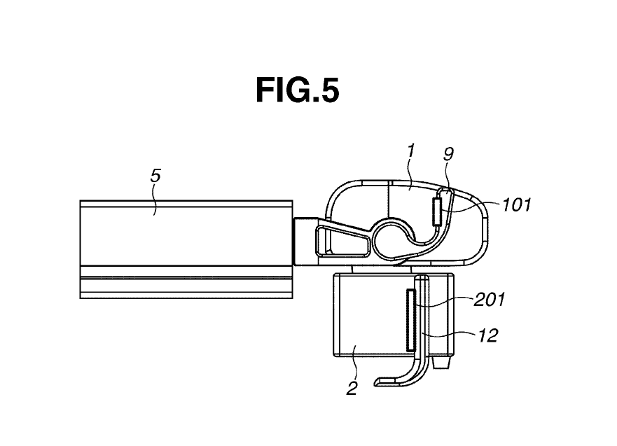

FIG. 5 is an external view of the X-ray generation unit according to the present embodiment as viewed from the side. The tube handle switch 101 and the collimator handle switch 201 are respectively arranged on side surfaces, on the side opposite to a position of the operator 21 illustrated in FIG. 1, of the tube handle 9 and the collimator handle 12 so that the switches can naturally be pressed when the operator 21 grips the handles.

An example of an operation during imaging using the above-mentioned X-ray generation unit will be described. The entire mobile X-ray generation apparatus becomes movable when the operator 21 grips the moving handle 11 and turns on a moving handle switch (not illustrated). The mobile X-ray generation apparatus moves to an X-ray imaging position when the drive wheel 15 is driven by operating the moving handle 11.

If the mobile X-ray generation apparatus reaches the imaging position serving as a destination, the moving handle 11 gripped during movement is replaced with the tube handle 9 to press the tube handle switch 101 or 102 in the tube handle 9, to release locking and pull the X-ray tube unit 1 upward.

The X-ray tube unit 1 is then moved to the vicinity of an upper imaging position of a subject (not illustrated) lying on a bed, to arrange an FPD for imaging between the subject and the bed. Fine adjustment up to the imaging position of the X-ray tube unit 1 is performed by unlocking the positioning member with the collimator handle switch 201 or 202 in the collimator handle 12 and moving the positioning member. This completes a series of imaging preparations.

Then, X-ray imaging uses a similar method to that used in a general X-ray imaging apparatus. When a touch panel of the monitor 10 or another input device sets an imaging condition, and an irradiation switch (not illustrated) is pressed, the X-ray tube unit 1 irradiates X-rays, and the collimator 2 below the X-ray tube unit 1 shapes the irradiated X-rays. The shaped X-rays penetrate the body of the subject so that an image is captured with an imaging flat panel. The captured image is transmitted to the system control unit 3 without wires or with wires (not illustrated), and can be confirmed on the monitor 10.

The system control unit 3 can perform control to release locking by pressing both two lock release switches under a specific condition and not to release locking even by pressing only one of the lock release switches. For example, the system control unit 3 releases locking to move the X-ray tube unit 1 upward as long as both the tube handle switches 101 and 102 serving as the two lock release switches provided in the pair of tube handles 9a and 9b are pressed when the collimator 2 is positioned within a specific range from the stored state.

Thus, a sensor for obtaining position information of the X-ray generation unit to be moved by the positioning member is provided in the positioning member. For example, sensors for detecting a movable state are respectively provided in the movable members of the positioning members, such as the arm 5 and the support post 4, and the system control unit 3 processes respective outputs of the sensors. Information output from the sensors includes information representing an expanded/contracted state and an elevated state of the arm 5 and an expanded/contracted state of the support post 4, i.e., position information of the X-ray generation unit provided at an end of the arm 5. Information representing the specific range, which does not interfere with another structure of the mobile X-ray generation apparatus, is retained in a memory of the system control unit 3 in consideration of the sizes of the positioning member and the X-ray generation unit. The system control unit 3 determines whether the collimator 2 is within the specific range from the output of the sensor and the information representing the specific range. The specific range can be within 50 cm above the storage portion 7, for example.

Thus, if a position of the X-ray generation unit is within the specific range, which does not interfere with the main body at this time, for example, the system control unit 3 can perform control so that the X-ray tube unit 1 cannot be raised upward unless respective movement locks in the tube handle switches 101 and 102 in the left and right tube handles 9a and 9b are simultaneously released. Thus, both the hands of the operator 21 are always respectively at positions of the tube handles 9a and 9b. Therefore, safety is ensured.

Similarly, the system control unit 3 releases locking to move the X-ray tube unit 1 downward as long as both the tube handle switches 101 and 102 are pressed when the collimator 2 is positioned within the specific range from the stored state.

At this time, the system control unit 3 can perform control so that the X-ray tube unit 1 cannot be lowered downward unless both the respective movement locks in the tube handle switches 101 and 102 in the left and right tube handles 9a and 9b are simultaneously released up to a storage position of the main body. Thus, both the hands of the operator 21 are always respectively at positions of the tube handles 9a and 9b. Therefore, safety is ensured.

An operation for storing the collimator 2 into the main body with the tube handles 9a and 9b, which are synchronized with the X-ray tube unit 1, can be performed when the collimator 2 reaches a position above the storage position of the main body serving as the specific range that does not interfere with the main body and is close thereto.

Thus, the system control unit 3 controls the positioning member to perform different operations when any one of the switches 101, 102, 201 and 202 is pressed and when the switch and a switch different from the switch are simultaneously pressed. By using such a control system, operability can be improved by controlling an operation according to a situation in response to an instruction from the operator 21 if the positioning member can move the X-ray generation unit with multiple degrees of freedom to change an arrangement.

From another viewpoint, the system control unit 3 is responsive to the switch being pressed for controlling an operation of the positioning member while changing the control performed when the switch is pressed according to the position information obtained by the sensor. By using such a control system, the positioning member can be controlled according to the situation because the operation of the positioning member is changed according to the position information.

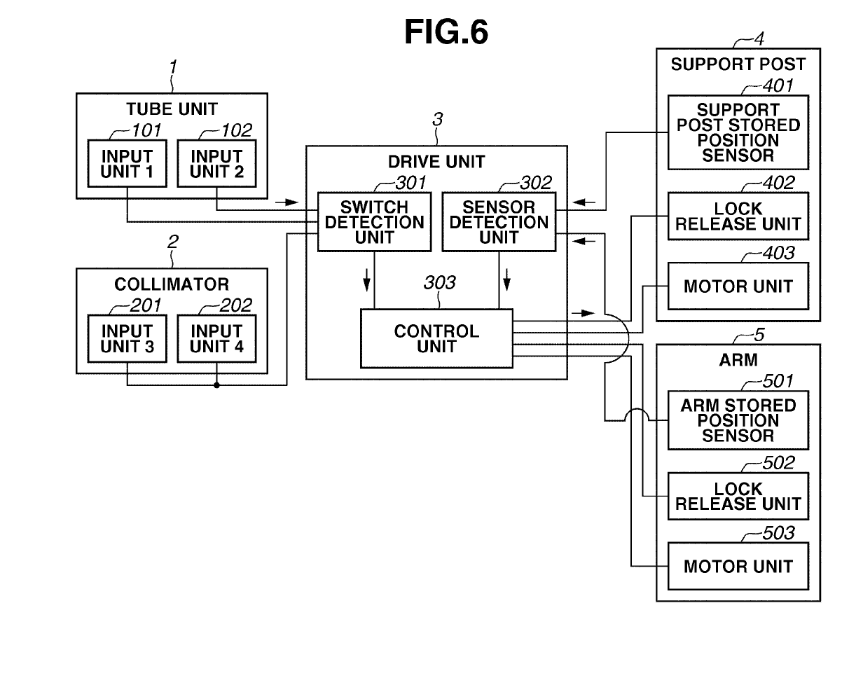

A specific example of a control system in a mobile X-ray generation apparatus will be described with reference to FIG. 6. In FIG. 6, components assigned the same reference numerals as those of the above-mentioned components are similar to the components.

The mobile X-ray generation apparatus according to the present embodiment includes an X-ray tube unit 1, a collimator 2, a support post 4 and an arm 5 each serving as a positioning member, and a drive unit (a system control unit) 3 for processing respective inputs from such units to operate the positioning member. A plurality of input units 101 and 102 each composed of a switch is mounted on the X-ray tube unit 1. A plurality of input units 201 and 202 each composed of a switch are mounted on the collimator 2.

The support post 4 includes a support post stored position sensor 401, a lock release unit 402, and a motor unit 403 for driving the support post 4, which are mounted in its inner part. The arm 5 includes an arm stored position sensor 501, a lock release unit 502, and a motor unit 503 for driving the arm 5, which are mounted in its inner part.

The drive unit (system control unit) 3 includes a switch detection unit 301 for detecting respective inputs from the input units 101, 102, 201, and 202, and a sensor detection unit 302 for detecting an input from the arm stored position sensor 501. The drive unit 3 further includes a control unit 303 for issuing an instruction to the lock release units 402 and 502 and the motors 403 and 503 based on respective inputs from the switch detection unit 301 and the sensor detection unit 302.

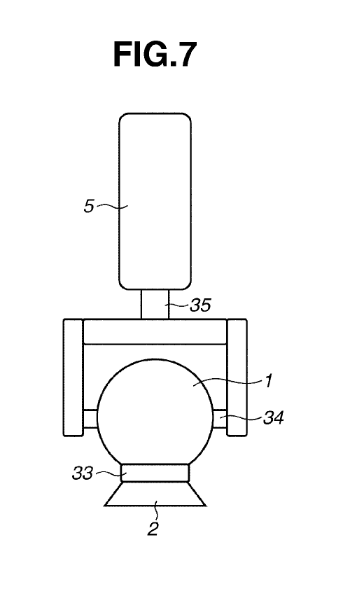

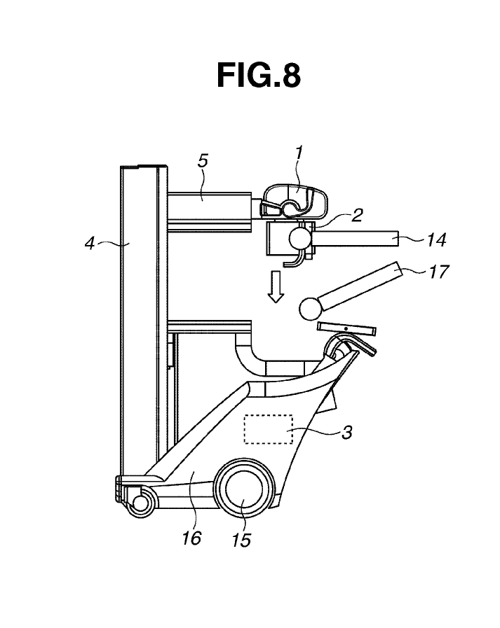

FIG. 7 illustrates an example of a specific configuration of the X-ray generation unit. In an example illustrated in FIG. 8, the X-ray generation unit includes various types of rotation mechanisms, and the rotation mechanisms are controlled to operate according to the respective inputs from the input units (switches) 101, 102, 201, and 202. The rotation mechanisms enable the X-ray tube unit 1 and the collimator 2 to be directed in a direction other than a vertical direction and enables movement with a high degree of freedom, e.g., oblique radiography.

A rotation mechanism 33 rotates the collimator 2 with respect to the X-ray tube unit 1. The rotation mechanism 33 enables an X-ray irradiation area to be rotated while maintaining an irradiation field shape restricted by the collimator 2. A rotation mechanism 34 tilts the X-ray tube unit 1. A rotation mechanism 35 rotates the X-ray tube unit 1 around a shaft passing through the length of the arm 5. The rotation mechanisms 33 to 35 respectively include units composed of non-excitation operation brakes for stopping the rotation. The unit for stopping the rotation may use a permanent electromagnetic holder to attract rotational axes of the rotation mechanisms 33 to 35. The permanent excitation holder is an example of an operation regulation member for regulating an operation by energization.

Thus, the sensor detection unit 302 detects that the X-ray tube unit 1 is at the stored position during movement according to respective inputs from the support post stored position sensor 401 and the arm stored position sensor 501, and can stop the rotations by the rotation mechanisms 33 to 35 when the X-ray tube unit 1 is at the stored position during movement.

The rotation mechanism 33 enables the collimator 2 to rotate in an emission direction. A radiation beam bundle to be shaped by the collimator 2 can be shaped into a circular shape or a square shape. If the collimator 2 shapes the radiation beam bundle, for example, into a square shape, as viewed in the emission direction, an appropriate irradiation area can be set even if an X-ray imaging device having a rectangular detection area is arranged at any position and posture to match an imaging form. The control unit 303 can apply control to restrict the rotation in the emission direction of the collimator 2. This can reduce the possibility that the collimator 2 collides with the monitor 10 or a fixing member for the monitor 10. If the collimator 2 may not collide with another member of the mobile X-ray generation apparatus, such as the monitor 10, depending on the rotation, control can be performed not to regulate the rotation of the collimator 2.

The rotation mechanism 34 included in the positioning member can tilt the X-ray tube unit 1. “Tilting” means an operation for rotating the X-ray tube unit 1 around one axis passing near the center of the X-ray tube unit 1 and perpendicular to the emission direction. The control unit 303 can apply control to restrict a tilt operation of the X-ray tube unit 1 by the rotation mechanism 34. Regulation of the tilt operation can avoid the possibility that the collimator 2 collides with a member such as the monitor 10, for example.

The rotation mechanism 35 included in the positioning member can rotate the X-ray tube unit 1 in the axial direction of the arm 5. The control unit 303 can restrict the rotation of the X-ray tube unit 1 by the rotation mechanism 35. This can reduce the possibility that the X-ray tube unit 1 or the arm 5 collides with another member in the mobile X-ray generation apparatus.

A stored position or a non-imaging position may be at least any of a position determined as a position of the X-ray generation unit when the mobile X-ray generation apparatus moves, a position of the X-ray generation unit where the mobile X-ray generation apparatus is included in an irradiation range, and a position at which generation of X-rays by the X-ray generation unit is restricted in addition to the above-mentioned definition. In any case, when the X-ray generation unit is at the stored position, the control unit 303 inhibits an operation of the positioning member other than an operation for safely moving the X-ray generation unit to a non-stored position. Thus, an impact on the mobile X-ray generation apparatus is reduced, and convenience in use is improved. The operator 21 can be alerted by displaying a figure and an icon on the monitor 10 to perform an operation for safely moving, when the X-ray generation unit is at the stored position, the X-ray generation unit from the stored position according to control by the control unit 303.

The non-excitation operation brakes composing the rotation mechanisms 33 to 35 in the X-ray generation unit are released in response to the input units 101, 102, 201, and 202 being pressed according to control by the control unit 303. The rotation mechanism 33 in the collimator 2 is responsive to either of the input units 201 and 202 in the collimator 2 being pressed for outputting a signal for causing the control unit 303 to deregulate the operation by the non-excitation operation brake. The rotation mechanism 34 for tilting the X-ray tube unit 1 is unlocked in response to either of the input units 201 and 202 in the collimator 2 being pressed. Instead thereof or in addition thereto, the non-excitation operation brake composing the rotation mechanism 34 may be released in response to either of the input units 101 and 102 in the X-ray tube unit 1 being pressed. Further, the control unit 303 unlocks the rotation mechanisms 33 to 35 in the X-ray generation unit and does not unlock the support post 4 and the arm 5 if the input units 201 and 202 in the collimator 2 are pressed in consideration of a case where the arm 5 elevates with respect to the support post 4 and a case where the arm 5 expands/contracts. On the other hand, the control unit 303 does not unlock the rotation mechanisms 33 to 35 in the X-ray generation unit and does not unlock the support post 4 and the arm 5 if the input units 101 and 102 in the X-ray tube unit 1 are pressed. Thus, rough movements such as movement of the X-ray generation unit into and out of the storage portion 7 are performed with the handle 9 in the X-ray tube unit 1. Fine movements such as movement of an irradiation range and rotation of the X-ray generation unit are performed with the handle 12 in the collimator 2 so that each of the movements can be easily performed.

The operator 21 can expand/contract the support post 4 in a vertical direction, rotate the arm 5 around the support post 4, and move the arm 5 in a longitudinal direction by mainly operating the input units 101 and 102 mounted in the X-ray tube unit 1. The support post 4 and the arm 5 respectively include lock release units 402 and 502 such as permanent electromagnetic locks in which they are fixed not to move with a magnetic force while there are no inputs from the input units 101 and 102, and the magnetic force disappears only when there are inputs from the input units 101 and 102. The support post 4 and the arm 5 are respectively driven by the motor units 403 and 503 to assist loads during movements of the support post 4 and the arm 5 by the operator 21 after being unlocked by the lock release units 402 and 502. Thus, rotational movement, longitudinal movement, and vertical movement of the arm 5 around the support post 4 and a rotational movement of the support post 4 are performed. The X-ray tube unit 1 can be tilted, and the arm 5 can rotate in the axial direction. If the input units 201 and 202 in the collimator 2 are operated, the rotation in an emission direction of the collimator 2 is also unlocked in addition thereto.

The operations enable the operator 21 to move the X-ray tube unit 1 and the collimator 2, respectively, to desired positions.

The handle 12 and the input units 201 and 202 mounted in the collimator 2 are used to rotate only the collimator 2 with respect to the X-ray tube unit 1, and are mainly used to finally adjust an exposure range after the X-ray tube unit 1 and the collimator 2 are moved, respectively, to the desired positions.

The control unit 303 can perform, in addition to first control to control the movable members of the positioning members in response to any one of the input units (a first switch) being pressed, second control, different from the first control, performed in response to the first switch and the input unit (a second switch) different from the first switch being simultaneously pressed. Thus, control to change control of the positioning member is performed depending on whether the first switch is pressed or the first switch and the second switch are simultaneously pressed so that the operator 21 can implement an operation of the positioning member according to a situation.

For example, as the first control serving as normal control, the switch detection unit 301 detects a signal indicating that any one of the input units is pressed, and the control unit 303 sends an instruction signal to the lock release unit 502 to deregulate an operation by the operation regulation unit of the deadman lock type such as the non-excitation operation brake in response to the detection. Thus, the operations of the movable members of the support post and the arm 5 each serving as the positioning member are deregulated, and the positioning member can be moved according to an operation force of the operator 21. As the second control, control is performed not to perform, if either of the input units 101 and 102 in the X-ray tube unit 1 and either of the input units 201 and 202 in the collimator 2 are simultaneously pressed, the first control. This is implemented when the control unit 303 stops sending a signal for deregulating the operation regulation unit and shifts the operation regulation unit to a locked state or maintains the locked state in response to the switch detection unit 301 detecting a signal indicating that any two of the input units are simultaneously pressed. Thus, all respective movement operations of the support post 4 and the arm 5 are stopped, for example.

On the other hand, the first control is performed as a normal operation when the input units 101 and 102 in the X-ray tube unit 1 are simultaneously pressed and when the input units 201 and 202 in the collimator 2 are simultaneously pressed.

The meaning of control, like in the above-mentioned example, is as follows. The input units 101 and 102 mounted in the X-ray tube unit 1 and the input units 201 and 202 mounted in the collimator 2 are not simultaneously used in a general use. However, if the switch detection unit 301 detects input from the input unit 201 in the collimator 2 while the operator 21 operates the input unit 101 in the X-ray tube unit 1 due to force majeure, the control unit 303 issues instructions to respectively lock the lock release unit 402 in the support post 4 and the lock release unit 403 in the arm 5, to stop operations. The operations are also similarly stopped when there are respectively inputs to the input units 101 and 102 in the X-ray tube unit 1 while there are inputs to the input units 201 and 202 in the collimator 2. This can avoid the possibility that the collimator 2 rotates to cause an unintended problem during expansion/contraction in a vertical direction of the support post 4, rotation around the support post 4, and movement in a longitudinal direction of the arm 5 according to the input from the input unit 101. Thus, a subject of X-ray imaging or a radiation technologist who is operating a visiting car provides a safe X-ray imaging environment.

FIG. 8 illustrates control performed when the X-ray generation unit is stored in the storage portion 7 according to the present embodiment. The X-ray tube unit 1 is generally moved to a desired position when stored, and the X-ray tube unit 1 and the collimator 2, which have performed X-ray imaging, are respectively returned to stored positions.

The control unit 303 maintains the regulation of the operations of the movable members if one of the plurality of input units provided in either of the X-ray tube unit 1 and the collimator 2 is pressed under a specific condition, but can use control to deregulate the operations of the movable members if more than one of the provided plurality of input units is simultaneously pressed. More specifically, while a brake is unlocked with one of the input units in a normal state, the operation is deregulated only if the two input units 101 and 102 in the X-ray tube unit 1 are simultaneously pressed or the two input units 201 and 202 in the collimator 2 are simultaneously pressed, in consideration of safety and reliability in a specific situation.

Each of the support post 4 and the arm 5 each serving as the positioning member includes a sensor for obtaining position information of the X-ray tube unit 1 that is moved thereby. When the X-ray tube unit 1 and the collimator 2 are respectively returned to the stored positions, the support post stored position sensor 401 mounted in the support post 4 detects that a rotation position of the arm 5 around the support post 4 is at the stored position. The arm stored position sensor 501 mounted in the arm 5 detects that the arm 5 is at the stored position. Whichever of the support post stored position sensor 401 and the arm stored position sensor 501 may be detected first. When the sensor detection unit 302 detects from the support post stored position sensor 401 and the arm stored position sensor 501 that the support post 4 and the arm 5 are respectively at stored positions, the control unit 303 performs control to permit movement in a vertical direction of the support post 4 only if there are respectively inputs from both the input units 101 and 102 in the X-ray tube unit 1.

The support post 4 is at the stored position when rotating so that the arm 5 faces a direction opposite to the forward movement direction, for example. The arm 5 is at the stored position when the X-ray generation unit is in an extracted/contracted state to fall within the storage portion 7, e.g., in a most contracted state. The X-ray generation unit is at the stored position when the X-ray generation unit is stored in the storage portion 7, e.g., when a stopper member provided on an exit surface of the collimator 2 to project from the exit surface contacts a bottom surface of the storage portion 7.

A situation where both the input units 101 and 102 in the X-ray tube unit 1 are operated is substantially equal to a situation where the operator 21 has the handle 9 in the X-ray tube unit 1 with his/her hands, and is control to return the X-ray tube unit 1 and the collimator 2, respectively, to the stored positions only if the operator 21 operates both the input units 101 and 102 with his/her hands. Thus, the drive unit (system control unit) 3 uses the position information obtained by the sensor as a specific condition, previously described, to change control performed when the input units are pressed in response thereto.

In the above-mentioned example, a criterion for determination is whether the X-ray generation unit is at the stored position. However, the stored position may be provided with a certain range so that it is determined that the X-ray generation unit is at the stored position if within the specific range. Alternatively, even if the X-ray generation unit is slightly spaced apart from the stored position, the above-mentioned control is used if the X-ray generation unit is within the specific range. An operation in a vertical direction may be deregulated only if the two input units are simultaneously pressed.

From another viewpoint, the control unit 303 outputs a signal for unlocking the positioning member depending on whether the X-ray tube unit 1 is positioned within the specific range when the input unit is pressed. For example, control can be used not to unlock the positioning member when one of the input units is pressed, as described above. In another example, if the X-ray generation unit is specified to be positioned in the specific range regardless of the number of pressed input units, control can be performed so that the positioning member cannot be unlocked without a dedicated switch separately provided. For example, the specific range can be a range in which the X-ray generation unit and the arm 5 interfere with another member in the mobile X-ray generation apparatus to reduce the possibility that a malfunction due to interference or collision occurs.

Information representing the above-mentioned specific range is stored in a memory (not illustrated) in the drive unit (system control unit) 3, for example. The control unit 303 refers to the information, as needed.

This can reduce the possibility that if the operator 21 operates the X-ray generation unit with one hand 14, as illustrated in FIG. 8, the other hand 17 is sandwiched between the X-ray tube unit 1 or the collimator 2 and the cart 16.

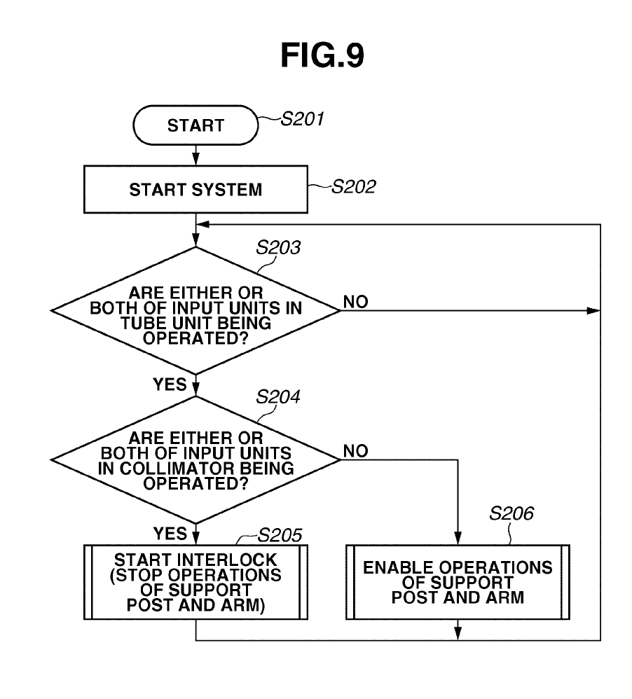

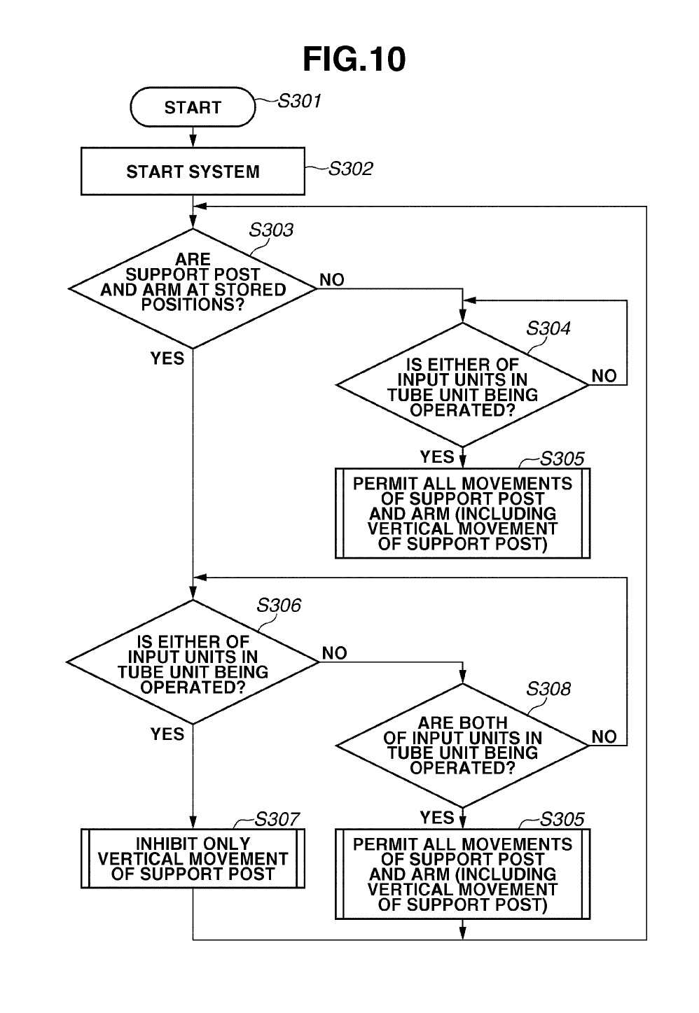

FIGS. 9 and 10 are flowcharts illustrating an example of an operation of an X-ray imaging system according to the present embodiment. First, in steps S201 and S202, the X-ray imaging system is started. In step S203, the switch detection unit 301 detects whether either or both of the input units 101 and 102 in the X-ray tube unit 1 are being operated.

If either or both of the input units 101 and 102 are operated (YES in step S203), then in step S204, the switch detection unit 301 detects whether either or both of the input units 201 and 202 in the collimator 2 are being operated while either or both of the input units 101 and 102 in the X-ray tube unit 1 are being operated. If either or both of the input units 201 and 202 in the collimator 2 are being operated (YES in step S204), then in step S205, the switch detection unit 301 starts an interlock, to stop respective operations of the support post 4 and the arm 5. If either or both of the input units 201 and 202 in the collimator 2 are not being operated (NO in step S204), then in step S206, the switch detection unit 301 enables the respective operations of the support post 4 and the arm 5.

FIG. 10 is a flowchart specialized in a case where the X-ray imaging system is returned to a stored state. In steps S301 and S302, the X-ray imaging system is started. In step S303, the sensor detection unit 302 detects whether both the support post 4 and the arm 5 are respectively at stored positions based on outputs of the support post stored position sensor 401 and the arm stored position sensor 501. If either of the support post 4 and the arm 5 is not at the stored position (NO in step S303), then in step S304, the sensor detection unit 302 confirms whether either of the input units 101 and 102 in the X-ray tube unit 1 is being operated. If either of the input units 101 and 102 is being operated (YES in step S304), then in step S305, the sensor detection unit 302 permits all movements of the support post 4 and the arm 5. In this state, if the input units 201 and 202 in the collimator 2 are being operated, the processing illustrated in FIG. 9 is performed.

If it is confirmed that the support post 4 and the arm 5 are respectively at the stored positions (YES in step S303), then in step S306, the switch detection unit 301 confirms whether either of the input units 101 and 102 in the X-ray tube unit 1 is being operated. Unless either of the input units 101 and 102 in the X-ray tube unit 1 is being operated (NO in step S306), then in step S308, the sensor detection unit 302 determines whether both the input units 101 and 102 in the X-ray tube unit 1 are being operated (i.e., the operator 21 operates the handle 9 in the X-ray tube unit 1 with his/her hands, as described above). If both the input units 101 and 102 in the X-ray tube unit 1 are being operated (YES step S308), then in step S305, the switch detection unit 301 permits all the movements of the support post 4 and the arm 5. On the other hand, if either of the input units 101 and 102 in the X-ray tube unit 1 is being operated (YES in step S306), then in step S307, the switch detection unit 301 inhibits only the movement in a vertical direction of the support post 4.

As described above, the control unit 303 maintains regulation of an operation of the movable member if one of the plurality of input units provided in one of the X-ray tube unit 1 and the collimator 2 is pressed when the X-ray tube unit 1 is specified to be at a position in the specific range according to position information from the sensor, and deregulates the operation of the movable member if more than one of the plurality of input units provided in one of the X-ray tube unit 1 and the collimator 2 is simultaneously pressed. Thus, the operator 21 is required to perform a more deliberate operation in the specific range, unlike that in the other range. This can reduce the possibility that problems such as collision occur.

In the above-mentioned control, the control unit 303 is responsive to more than one of the provided plurality of input units being simultaneously pressed for deregulating the operation of the movable member when the collimator 2 is specified to be at the stored position according to the position information from the sensor.

The control unit 303 is responsive to more than one of the plurality of input units provided in the X-ray generation unit being simultaneously pressed for deregulating the operation of the movable member for moving the X-ray generation unit downward when the X-ray generation unit is specified to be positioned within the specific range above the stored position according to the position information from the sensor.

The X-ray generation unit is made operable by pressing both switches provided therein when thus moved near the stored position. This can reduce the possibility that contact or collision occurs. If each of handles provided on two surfaces on opposite sides of the X-ray generation unit includes one switch, as described above, the hands of the operator 21 are requested to be respectively on the handles. This can reduce the possibility that a hand or a finger is pinched between the X-ray generation unit and another structure.

From another viewpoint, the control unit 303 performs control based on a combination of pressed states (first states) or non-pressed states (second states) for the input units provided in the X-ray tube unit 1 and the collimator 2. Therefore, the operator 21 can appropriately operate the positioning member according to a situation using the plurality of input units or reduce problems such as collision due to the operator 21.

Another embodiment will be described below. An operation of a movable member need not necessarily be stopped as regulation of an operation of a positioning member, unlike in the above-mentioned embodiment. For example, a brake may regulate the operation of the positioning member so that the speed of a moving operation is reduced by simultaneously pressing a plurality of switches. If each of an expansion/contraction mechanism of a support post 4 and an elevation mechanism of an arm 5 is provided with an electric mechanism such as an actuator, one of the switches may move the electric mechanism at a first speed, and two of the switches may automatically move the electric mechanism at a second speed higher than the first speed.

While each of the pair of handles provided in each of the X-ray tube unit 1 and the collimator 2 includes one switch mainly in the above-mentioned embodiment, the present invention is not limited to this. Each of an X-ray tube unit 1 and a collimator 2 may include three or more switches. Each of surfaces of the X-ray tube unit 1 may include one switch to perform the above-mentioned control in response to any two of the switches being pressed.

While the support post 4 extends in a vertical direction and the arm 5 extends in a horizontal direction in the above-mentioned example, the present invention is not limited to this. The support post 4 and the arm 5 may respectively extend in a first direction and a second direction different from the first direction. The support post 4 and the arm 5 may be together an arm of the link type or joint type. The arm may rotate around a joint. A mobile X-ray generation apparatus may have at least any one of functions such as expansion/contraction of the arm 5, elevation of the arm 5 with respect to the support post 4, and expansion/contraction and rotation of the support post 4.

While the imaging apparatus uses X-rays in the above-mentioned embodiment, the present invention is not limited to this. Imaging apparatuses using other types of radiation are included in an embodiment of the present invention.

While the X-ray tube unit 1 can use a reflection target of the rotating anode type, the present invention is not limited to this. A radiation generation unit including a transmission target of the fixed anode type can be used. In this case, a rotation mechanism of an anode is not required so that the imaging apparatus can be miniaturized. A request for the load bearing of a support structure is reduced. Thus, the arm 5 and the support post 4 can be made thinner so that the radiation generation unit can be made compact. Further, a structure other than at least the radiation generation unit can be manufactured at low cost.

The above-mentioned control unit is included in the embodiment of the present invention when implemented by cooperation of the program and hardware. In the embodiment using the program, a program corresponding to the above-mentioned processing is implemented when the program is stored in a storage portion and a central processing unit (CPU) in a control unit loads the program into a random access memory (RAM) and executes an instruction included in the program.

In addition, an appropriate combination of the above-mentioned embodiments is included in the present invention.

According to the above-mentioned embodiments, a storage portion, which protects a side surface of a collimator, is thus provided in a cart so that the collimator is protected during movement. In addition, a handle fixed to an X-ray tube unit makes it easy to move the X-ray tube unit to a stored position and move the X-ray tube unit from the stored position to an imaging position.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-227184 filed Oct. 12, 2012, which is hereby incorporated by reference herein in its entirety.

What is claimed is:

1. A mobile X-ray generation apparatus comprising:
an X-ray tube unit;
a collimator configured to shape an X-ray bundle generated by the X-ray tube unit;
a positioning member configured to arrange the X-ray tube unit and the collimator at respective specific positions;
a cart configured to support the positioning member;
a first handle fixed to the X-ray tube unit;
a second handle fixed to a side surface of the collimator; and
a storage portion provided in the cart and configured to protect an exit surface and the side surfaces of the collimator when the X-ray tube unit and the collimator in a stored state in which the X-ray tube unit and the collimator are brought into the storage portion.

2. The mobile X-ray generation apparatus according to claim 1, wherein, in the stored state, at least a part of the second handle is retained within the storage portion.

3. The mobile X-ray generation apparatus according to claim 2, wherein the storage portion includes a wall member configured to cover the second handle when the X-ray tube unit and the collimator are brought into the storage portion.

4. The mobile X-ray generation apparatus according to claim 1, wherein the positioning member includes:
an arm coupled to the X-ray tube unit and arranged to alter the position of the X-ray tube unit; and
a support post connected to the arm and configured to elevate and rotate the X-ray tube unit.

5. The mobile X-ray generation apparatus according to claim 1, wherein the positioning member includes:
a support post fixed to the cart and configured to extend to be rotatable in an axial direction and expandable and contractable in a first direction; and
an arm connected between the support post and to the X-ray tube unit, and
wherein the support post is substantially fully contracted when the X-ray tube unit and the collimator are brought into the storage portion.

6. The mobile X-ray generation apparatus according to claim 1, further comprising:
a communication unit configured to wirelessly receive X-ray image data obtained by detecting X-rays emitted from an exit surface of the collimator from a digital X-ray imaging unit; and
a display unit configured to display the received X-ray image data,
wherein the display unit is fixed to a position vertically above the collimator in the stored state.

7. The mobile X-ray generation apparatus according to claim 1, wherein the first handle is fixed to a side surface of the X-ray tube unit, and
wherein the first handle includes a rod-shaped member extending in a direction opposite to a direction toward which an X-ray is emitted from of the X-ray tube unit.

8. The mobile X-ray generation apparatus according to claim 1, wherein the first handle is coupled to two surfaces of the X-ray tube unit, and
wherein the second handle is coupled to two surfaces of the collimator.

9. The mobile X-ray generation apparatus according to claim 1, wherein the first handle is provided at a position further away from an point where X-ray is emitted than the second handle.

10. The mobile X-ray generation apparatus according to claim 1, wherein the storage portion is a recessed portion obtained by reducing the height of an upper surface of the cart, and
wherein the recessed portion is configured to protect front and rear surfaces in the forward movement direction of the collimator, and the second handle of the collimator is exposed to be accessible from lateral sides.

11. The mobile X-ray generation apparatus according to claim 1, further comprising:
a communication unit configured to wirelessly receive X-ray image data obtained by detecting X-rays emitted from an exit surface of the collimator from a digital X-ray imaging unit, and
a display unit configured to display the received X-ray image data,
wherein the display unit is fixed to a position vertically above the exit surface of the collimator in the stored state.

12. The mobile X-ray generation apparatus according to claim 1, further comprising a switch provided on the first handle and configured to unlock the positioning member.

13. The mobile X-ray generation apparatus according to claim 12, further comprising:
an electric mechanism configured to operate a movable portion of the positioning member; and
an electric control unit configured to control the electric mechanism,
wherein the electric control unit unlocks the movable portion in response to the switch being pressed.

14. The mobile X-ray generation apparatus according to claim 1, wherein at least one of the first handle and the second handle includes two handle portions, each of which includes a lock release switch and is configured to unlock a movable portion of the positioning member; and
a control unit configured to perform control, under a specific condition, to release the locking of the movable portion in response to pressing of both the lock release switches and not to release the locking of the movable portion in response to the pressing of only one of the lock release switches.

15. The mobile X-ray generation apparatus according to claim 14, wherein the first handle includes two first handle portions provided on the X-ray tube unit,
wherein the lock release switches are respectively provided on the two first handle portions, and
wherein, when the collimator is to be positioned within a specific range from the stored state, the control unit releases the locking of the movable portion to move the X-ray tube unit upward, as long as the two lock release switches are pressed.

16. The mobile X-ray generation apparatus according to claim 14, wherein the first handle includes two first handle portions provided on the X-ray tube unit,
wherein the lock release switches are respectively provided on the two first handle portions, and
wherein, when the collimator is to be moved from a first position to the storage position, the control unit releases the locking of the movable portion to move the X-ray tube unit downward, as long as the two lock release switches are pressed.

17. A mobile X-ray imaging system comprising:
the mobile X-ray generation apparatus according to claim 1; and
a portable digital X-ray detection unit including an X-ray image sensor configured to detect X-rays emitted from the mobile X-ray generation apparatus, and a communication unit configured to transfer digital X-ray image data obtained by the X-ray image sensor to the mobile X-ray generation apparatus.
